(19) United States
(12) Patent Application Publication
(10) Pub. No.: US 2004/0113840 A1
(43) Pub. Date: Jun. 17, 2004

(54) Antenna assembly

(76) Inventors: Frank Gottwald, Weissach (DE); Klaus Voigtlaender, Wangen (DE); Tore Toennesen, Reutlingen (DE); Andre Moeller, Reutlingen (DE); Jens Haensel, Leonberg (DE)

Correspondence Address: KENYON & KENYON, ONE BROADWAY, NEW YORK, NY, 10004, US

(21) Appl. No.: 10/451,445

(22) PCT Filed: Dec. 18, 2001
(86) PCT No.: PCT/DE01/04726

(30) Foreign Application Priority Data
Dec. 20, 2000 (DE) 100 63 437.0

(51) Int. Cl. H01Q 1/38; H01Q 1/48

(52) U.S. Cl. 343/700 MS; 343/846

(57) ABSTRACT

The present invention provides an antenna array for ascertaining the distance between vehicles and their speed, which includes devices for receiving or transmitting signal waves, a multi-layer carrier situated underneath the devices, a first potential surface, which is at ground and which is situated on the surface of the carrier facing the devices, coupling devices located in the first potential surface, electrical connecting sections disposed as closely as possible underneath the first potential surface, and a second potential surface which is located underneath the connecting sections and is at mass.

### BACKGROUND INFORMATION

The present invention is directed to an antenna array and, in particular, a slot-coupled antenna array for ascertaining the distance between motor vehicles or their speed.

Although able to be used in any field of application in the antenna sector, the present invention and the problem definition on which it is based are explained with reference to an antenna array on board a motor vehicle to ascertain the distance between motor vehicles or their speed.

Systems are already known in which the distance and the speeds are measured by radar (microwaves), especially short-range radar. Currently, radiator-surface antenna arrays (patch antennas) are used, among others, in which radiator surfaces (patches) are mounted directly on substrate materials or on top of foam materials. The radiator surfaces are excited either on the antenna side by feed lines or by coupling slots. The feed lines may be accommodated on an additional material, which is a different material in most cases, and the individual layers or coatings must be interconnected on top of each other. However, these antenna arrays have the disadvantage that the relative adjustment and the precise positioning of the individual material layers is highly complicated and difficult to implement.

Furthermore, Applicant has knowledge of antenna arrays, which are manufactured according to a so-called triplate technology, electric connecting sections being arranged between two metallic coatings. Such antenna arrays are made up, for instance, of individual perforated metal plates, foils with antenna structures or feed lines and of foam intermediate layers. The individual layers are assembled by screw fitting, for example, and secured to prevent slippage. As a result of the fairly complicated design and the involved manufacturing process it requires, such antenna arrays are quite expensive.

An additional antenna array of which the Applicant is aware is set up on a laminated printed-circuit board made up of an FR4 substrate, for example. A so-called softboard is laminated onto the printed circuit board, coupling slots being provided on one side of the softboard. A area is milled out from the FR4-substrate, foam material is inserted in this milled-out surface and the metal radiator surfaces, i.e., patches, are affixed thereon by means of a film, for example. This approach has the disadvantage of requiring a complicated manufacturing method, since holes must be milled out and foams inserted.

In addition, spurious radiation outside the useful frequency occurs in all known arrays, caused by processor pulses, radiation from components etc., for instance, and it is difficult to prevent it. Also, because of feed lines, for example, considerable portions of the useful electromagnetic radiation is radiated in undesired directions, such as in the direction of the vehicle frame or vehicle engine, and may have a detrimental effect on components installed in these areas.

Therefore, the underlying problem definition of the present invention, in general, is to provide an antenna array that has a compact design and reduces an electromagnetic radiation in unwanted directions.

### ADVANTAGES OF THE INVENTION

The antenna array according to the present invention, having the features of Claims 1 or 2, has the advantage over the known design approaches that the manufacturing process is facilitated, a more compact sensor is provided as well as excellent shielding from the electromagnetic energy or from energy waves in unwanted radiation directions.

A compact and easy to manufacture antenna array results from an appropriate arrangement of the electrical connecting sections within the multi-layer carrier between the first potential surface and the second potential surface, as closely as possible underneath the first potential surface. If the connecting sections are correspondingly arranged as closely as possible underneath the first potential surface, the major part of the electromagnetic radiation may be forced upward via the coupling devices, by way of the connecting sections, the same providing a shield toward the bottom in the direction of the second potential surface, so that the radiation occurring beneath the antenna array is low.

Advantageous further refinements and improvements of the antenna array specified in Claims 1 or 2 are found in the dependent claims.

According to a preferred further refinement, at least one coupling device in each case is located at a predefined distance underneath a transmission and receiving device.

According to an additional preferred further refinement, at least one layer of the carrier is situated between the coupling devices and the connecting sections.

According to an additional preferred further refinement, at least one layer of the carrier is situated between the connecting sections and the second potential surface.

According to another preferred further refinement, the at least one layer of the carrier between the coupling devices and the connecting sections has a thickness that is less than that of the at least one layer between the connecting sections and the second potential surface. The at least one layer of the dielectric carrier between the coupling devices and the connecting sections advantageously has approximately one half or one third of the thickness of the at least one layer between the feed lines and the second ground plane. Since layers having a thickness of approximately 150 μm are advantageously produced for reasons of production engineering, and since these dimensions have an advantageous effect on the resonance characteristics of the array, the carrier may be produced from individual layers having such a thickness. However, the layer thicknesses and the number of individual layers thereon are not restricted to this configuration and may be modified in many ways.

According to an additional preferred further refinement, the transmission and/or receiving devices are embodied as right-angled radiator surfaces (patches). These patches form an advantageous resonator, which is easy to manufacture.

According to another preferred further refinement, the multi-layer dielectric carrier is made of a low-temperature ceramic (LTCC). This ceramic has a high dielectric constant, compact sensors being formed, which are made of a single material system. Moreover, LTCC is adapted to the expansion of silicon, and already at low temperatures (approximately 900° Celsius), a plurality of layers having appropriate structures located thereon is able to be joined by firing in a compact manner.

According to an additional preferred further refinement, the radiator devices are arranged in series, at a certain distance from each other. By an appropriate arrangement, a desired directivity characteristic or radiation direction, radiation power etc. may be achieved.

According to another preferred further refinement, the coupling devices are embodied as coupling slots. The coupling slots are provided for an electromagnetic excitation of the radiator surfaces. The coupling slots are advantageously produced by etching the first ground plane and in each case are centrically positioned underneath a radiator surface, each extending approximately across the breadth of a radiator surface. The corresponding dimensions are to be adapted to the desired resonance characteristics.

According to another preferred further refinement, the feed lines are formed perpendicularly to the coupling slots in a carrier plane. However, the coupling devices may also be arranged between different carrier planes, thereby reducing mutual interference.

According to an additional preferred further refinement, the antenna array includes plated-through holes to shield from electromagnetic radiation in a certain area, the plated-through holes being arranged in parallel to each other and perpendicularly to the layer plane of the dielectric carrier, especially between two ground planes. Furthermore, to form shielding chambers, the plated-through holes are advantageously set apart from each other at a distance that is less than the wavelength of the radiation to be shielded from.

According to an additional preferred further refinement, the radiator devices are applied on a suitable foam material.

According to another preferred further refinement, the radiator devices are mounted on a housing top of the array. In this way, a compact antenna array consists of only two parts, namely a substrate board and a top on which the radiator devices are mounted.

According to another preferred further refinement, the feed lines are electrically connected to a feed-network device located on an upper surface of the carrier by way of at least one contact device in each case. In this way, feed lines between layers of the carrier are controlled by a shared feed-network device, which is easy to mount. However, the supply-network device need not necessarily be affixed on the surface.

According to an additional preferred further refinement, the reflector devices, the potential surfaces, the connecting sections, the plated-through holes and the contact devices are made of an electrically conductive material, such as gold, silver, copper or aluminum.

According to another preferred further refinement, the connecting sections and/or contact devices are formed using microstrip and/or coplanar technology. This produces a compact sensor having large-area potential surfaces or ground planes, which are advantageous for shielding.

According to an additional preferred further refinement, the coupling slots may assume arbitrary forms.

### BRIEF DESCRIPTION OF THE DRAWING

Exemplary embodiments of the present invention are represented in the drawing and are explained in greater detail in the following description.

The figures show:

FIG. 1 A bottom view of the arrangement of a connecting section, a coupling device and a transmission and/or receiving device according to an exemplary embodiment of the present invention, showing the arrangement of the components with respect to each other;

FIG. 2 a perspective view of the arrangement in FIG. 1;

FIG. 3 a cross-sectional view of an antenna array configured according to a first exemplary embodiment of the present invention;

FIG. 4 a cross-sectional view of an antenna array configured according to a second exemplary embodiment of the present invention;

FIG. 5 a plan view of an antenna array configured according to an exemplary embodiment of the present invention; and

FIG. 6 a performance diagram of an antenna array, configured according to an exemplary embodiment of the present invention, in a certain frequency range.

### DESCRIPTION OF THE EXEMPLARY EMBODIMENTS

Identical reference numerals in the figures denote identical or functionally identical components.

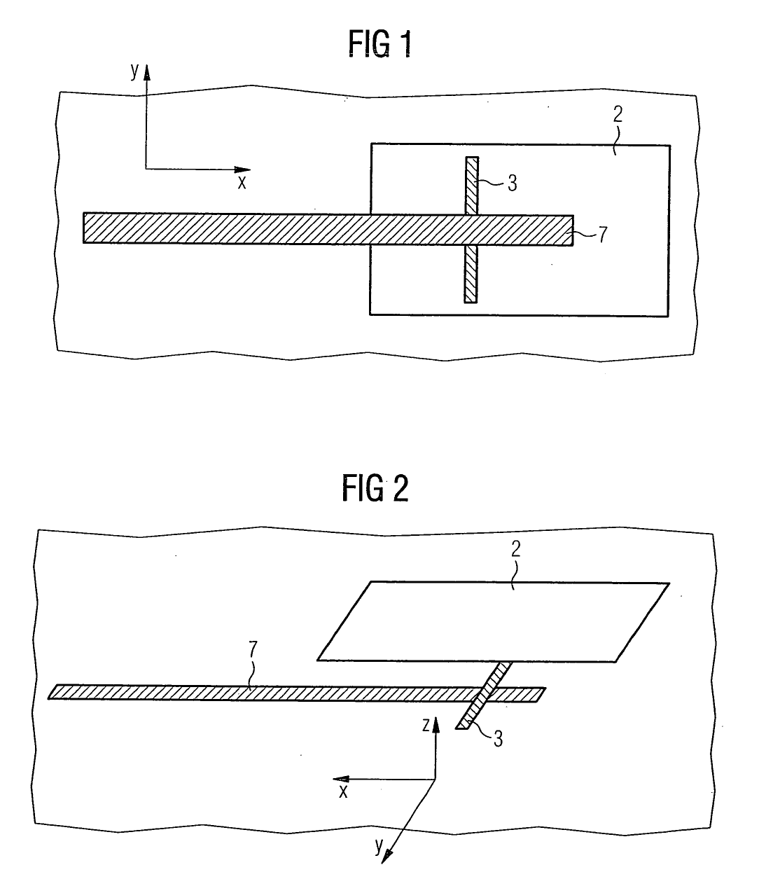

FIGS. 1 and 2 schematically show the arrangement of electrical connecting sections 7, in the form of feed lines 7, coupling devices 3, in the form of coupling slots 3, and transmission and/or receiving devices 2, in the form of radiator surfaces (so-called patches) 2. Such an array is called a slot-coupled patch antenna.

In FIGS. 1 and 2, the dielectric carrier (substrate) 5 and the first and second potential surfaces 4, 10, which are at ground, or ground planes 4, 10 have not been drawn in. The shown radiator surfaces 2 are either applied on a foam material or advantageously affixed on a housing top of the array (not shown).

The principle of a slot-coupled patch antenna will now be briefly discussed on the basis of FIGS. 1 and 2. Feed lines 7 are supplied with electromagnetic energy by a supply network device (not shown). Feed lines 7 are located underneath corresponding coupling slots 3 in such a way that electromagnetic energy is transmitted from supply lines 7 to coupling slots 3. Radiator surfaces 2, located above coupling slots 3, absorb the energy radiated by coupling slots 3 and, given appropriate positioning and extension, are thus brought into resonance. Radiator surfaces 2 therefore reradiate this energy with a certain quality, and it is possible by this arrangement to form a structure that is able to be precisely optimized within a frequency band.

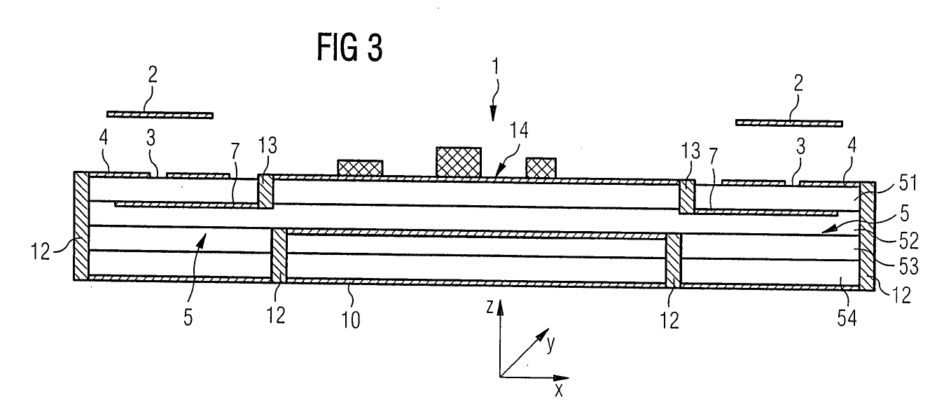

FIG. 3 represents a cross-sectional view of an antenna array configured according to a first exemplary embodiment of the present invention. Radiator surfaces 2 are fixedly mounted in a housing top (not shown), above dielectric carrier 5, for example.

Carrier 5 consists of a dielectric substrate, which is advantageously made up of an LTCC ceramic (low-temperature co-fired ceramic). This LTCC ceramic is a glass ceramic, suitable for high frequencies and produced in multi-layer technology. As a result, it is especially suited for use in the automotive sector for distance and/or speed measuring using radar in the Gigahertz range. In addition, the ceramic is able to be produced in a plurality of layers with a layer thickness of approximately 150 μm, for instance, and several layers may be stacked on top of each other. The overall structure may be optimally joined to the carrier plane (xy plane) by firing, already at relatively low temperatures, without this causing a change in geometry. Under high pressure, this glass ceramic shrinks only in the direction of the carrier axis (z-direction). Thus, a compact layer system results, which may be positioned with a high degree of precision.

In addition, the array includes a first ground plane 4, which is arranged on the surface of dielectric carrier 5 facing radiator surfaces 2. One coupling slot is in each case advantageously arranged in this first ground plane 4, at a certain distance underneath radiator surface 2, which is advantageously formed at a right angle. Coupling slots 3 are advantageously produced by etching of first ground plane 4. In addition, they each extend in a centric manner underneath a radiator surface 2, approximately across its breadth, as illustrated in FIG. 1. Coupling slots 3 are advantageously arranged in such a way that upper ground plane 4 is interrupted, each time at a distance of approximately a quarter of the wavelength of the electromagnetic radiation. Thus, by the reflection of the wave at the open end, it is reflected and summed up in correct phase relation with the arriving wave. Consequently, spherical waves are emitted at line 7 below coupling slot 3.

An excitation of coupling slots 3 is produced by electric feed lines 7, which according to the present invention are each situated underneath a coupling slot 3, a dielectric layer 51, having a thickness of approximately 150 μm, of carrier 5 being arranged between coupling slots 3 and feed lines 7.

For their triggering, feed lines 7, via contact devices 13, are connected to a supply-network device 14, i.e., the high-frequency switching component of the antenna sensor. For better insulation, the multi-layer technology allows feed lines 7 to also be guided in different planes, thereby largely excluding unwanted coupling effects. By guiding feed lines 7 to an upper surface of dielectric carrier 5, it is possible to position the components required for the triggering at a location that is low in radiation.

Furthermore, the antenna array configured according to the present invention has a second ground plane 10 located below feed lines 7, a plurality of layers 52, 53, 54 of dielectric carrier 5 being provided between feed lines 7 and second ground plane 10, the layers having a thickness of 150 μm.

By this asymmetrical tri-plate arrangement, in which feed lines 7 are positioned in closer proximity to coupling slots 3 or first ground plane 4 than they are to second ground plane 10, a higher field intensity is produced in the direction of coupling slots 3 upon excitation of feed lines 7. Therefore, the main portion of the energy is decoupled into the air, via coupling slots 3, and transmitted to the superposed radiator surfaces 2. Due to the greater distance to second ground plane 10, a smaller electric field is produced in this direction and consequently a smaller portion of the energy is radiated in this direction. In this way, the useful radiation, i.e., the portion of the electromagnetic energy in the direction of coupling slots 3 or radiator surfaces 2, is able to be increased.

In the first exemplary embodiment of the present invention, as shown in FIG. 3, only one ceramic layer 51 having a thickness of approximately 150 μm is situated between coupling slots 3 and feed lines 7, whereas three layers 52, 53, 54 each having a thickness of approximately 150 μm are located between the feed lines and lower second ground plane 10. However, it is possible to vary both the number of layers and the thickness of the individual layers according to the desired resonant characteristics or the desired antenna characteristic.

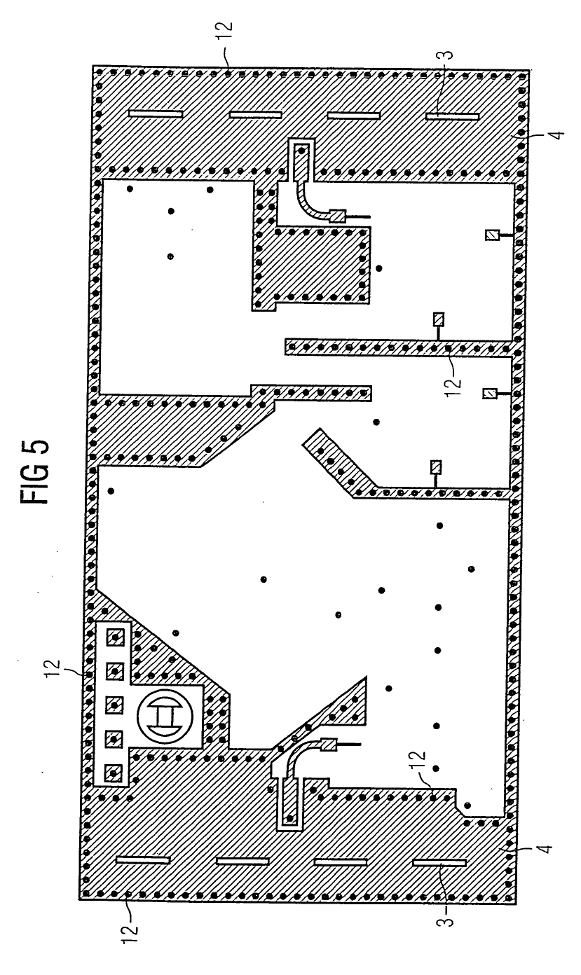

By arranging a plurality of radiator surfaces 2 and coupling slots 3 in series, for example at a predefined clearance with respect to each other, as is shown in FIG. 5, it is possible to adapt the desired performance gain, the opening angle and the suppression of secondary lobes to the requirements.

In addition, array 1 advantageously is provided with straight-through or partial plated-through holes 12, which, to shield from electromagnetic radiation, are advantageously located in a certain region, in parallel to each other and vertically in the z-direction of dielectric carrier 5.

Plated-through holes 12 are advantageously spaced apart from each other at a distance that is less than the wavelength of the radiation from which is to be shielded. Incorporating partition walls thus produces an inexpensive electromagnetic shield, since the chambers produced by the plated-through holes prevent the radiation propagating in undesired directions (x-y plane) from spreading in a harmful direction, so that secondary lobes are suppressed.

By a suitable selection of the chambering, even the vagabonding energy may be summed up in correct phase relation with the useful radiation. For instance, a bandwidth of more than 10% of the useful frequency may be generated by positioning a radiator surface 2 at a height that amounts to a twentieth up to a fifth part of the wavelength.

As already mentioned, the supply of antenna array 1 is carried out via an asymmetrical triplate arrangement. Feed lines 7 are located between individual layers, such as first layer 51 and second, third and fourth layers 52, 53, 57 of dielectric carrier 5. Since the components are usually located on the outer surfaces of the carrier, feed lines 7 may be positioned on the corresponding upper surface of carrier 5 through contact devices 13. At that point, microstrip technology is advantageously used. However, to facilitate the shielding measures, the use of a coplanar technology is also an option, as shown in FIG. 5, but adapter networks and/or distribution networks 14 may also be arranged, or buried, inside carrier 5.

Radiator devices 2, ground planes 4, 10, feed lines 7, plated-through holes 12 and contact devices 13 are advantageously made of a material that has good electric conductivity, such as gold, silver, copper or aluminum.

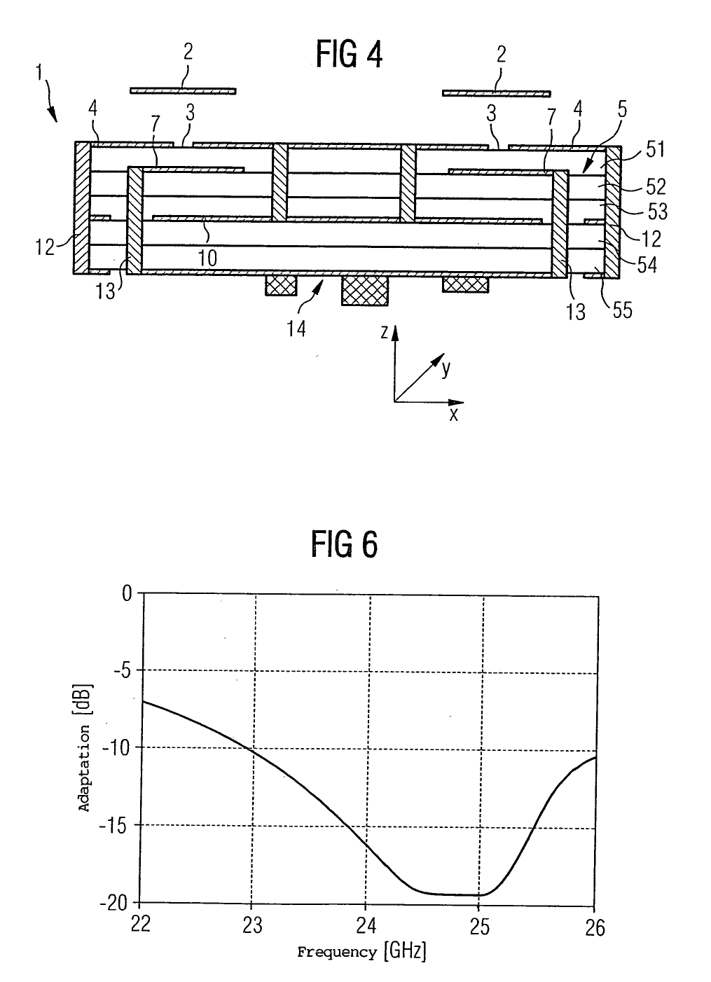

FIG. 4 represents a cross-sectional view of an antenna array 1 configured according to a second exemplary embodiment of the present invention.

Components or functioning methods not described in this exemplary embodiment are to be regarded as analogous to those of the first exemplary embodiment and therefore do not require any additional discussion.

In contrast to the first exemplary embodiment, supply network device 14, as can be seen from FIG. 4, is located on the surface of carrier 5 facing away from radiator surfaces 2, and therefore is positioned oppositely to the desired direction of radiation. Coupling slots 3 and supply network device 14 are on opposite surfaces of carrier 5. As a result, less space is required, on the one hand, which is advantageous for reasons of design, and the interference of the components due to scattered radiation is reduced, on the other hand.

Via contact devices 13, feed lines 7 are again brought to the surface on which supply network device 14 is located. As shown in FIG. 4, feed lines 7 are therefore guided to the bottom side of carrier 5.

The antenna array is once again embodied as an asymmetrical triplate line in an LTCC ceramic. By appropriate plated-through holes 12, shielded chambers are again produced for additional shielding.

The advantage of this second exemplary embodiment is, in particular, that it reduces the surface of the antenna array, although this goes hand in hand with an increase in thickness, since, compared to the first exemplary embodiment, an additional layer 55 is required in order to continue to avoid undesired resonance effects. However, since the thickness is increased by merely approximately 150 μm as a result of additional layer 55, a savings in length of approximately 1 to 2 cm is obtained, thus producing an antenna that is substantially more compact.

An additional advantage of this area-reducing design is that the antennas, relative to the components of supply network device 14, radiate in the opposite direction and thus do not disturb their functioning method.

Furthermore, as shown in FIG. 4, the antenna side has been provided with a metal coating over the entire surface and includes only coupling slots 3. No further switching components are located on the antenna side, so that an excellent shield is obtained.

By using appropriate plated-through holes 12, additional chambers may be formed, as shown in FIG. 5, to shield from electromagnetic radiation in undesired directions.

FIG. 6 shows a graphic representation of the adaptation, or the back-flow damping, of an antenna array according to the first exemplary embodiment of the present invention. At a mid-frequency of approximately 24 GHz, an adaptation of approximately 20 dB and a bandwidth of approximately 3 GHz result.

The present invention therefore provides a compact sensor, which is made of a small number of different materials, has high capacity in a predefined frequency range as well as clean directivity characteristics and excellent suppression of unwanted radiation in certain directions. Due to the large-area metal-plated ground planes on the upper and lower surface of the carrier, in combination with the asymmetrical triplate arrangement, the major part of the electromagnetic energy is forced to decouple via the coupling slots in the direction of the radiator surfaces. In addition, radiation in the direction of the carrier plane (x-y plane) is prevented because of additional plated-through holes.

Although the present invention was described above in terms of preferred exemplary embodiments, it is not limited thereto, but instead is modifiable in numerous ways.

With the selected arrangement and design, the problems known from the related art will not occur in the first place.

For instance, other substrate technologies, such as silicon, gallium arsenide (GaAs), softboard, FR4, ceramics having multi-layer coatings etc. may be used. Other layer thicknesses, frequency ranges or materials are conceivable as well.

What is claimed is:

1. An antenna array (1), in particular for ascertaining the distance between motor vehicles and their speed, comprising devices (2) for receiving or transmitting signal waves; a multi-layer carrier (5) situated underneath the devices (2); a first potential surface (4), which is at ground and disposed on the surface of the carrier (5) facing the devices (2); coupling devices (3) disposed in the first potential surface; electric connecting sections (7) situated in close proximity underneath the first potential surface (4); and having a second potential surface (10), which is at ground and located beneath the connecting sections.

2. The antenna array, in particular for ascertaining the distance between motor vehicles and their speed, having a multi-layer carrier (5);
a first potential surface (4), which is at ground and situated on the upper surface of the carrier (5);
coupling devices (3) disposed in the first potential surface;
a second potential surface (10), which is at ground and situated underneath the first potential surface (4), and having electric connecting sections (7), which are arranged between the first potential surface (4) and the second potential surface (10) between layers of the carrier (5) in such a way that the major part of the electromagnetic energy to be transmitted is able to be decoupled or injected via the coupling devices (3).

3. The antenna array as recited in one of claims 1 or 2, wherein at least one coupling device (3) is in each case arranged with a predefined clearance underneath a transmission and receiving device (2).

4. The antenna array as recited in one of the preceding claims,
wherein at least one layer (51) of the carrier (5) is situated between the coupling devices (3) and the connecting sections (7).

5. The antenna array as recited in one of the preceding claims,
wherein at least one layer (52, 53, 54, 55) of the carrier (5) is provided between the connecting sections (7) and the second potential surface (10).

6. The antenna array as recited in claims 4 and 5, wherein the at least one layer (51) of the carrier (5) has a reduced thickness between the couplings devices (3) and the connecting sections (7) than the at least one layer (52, 53, 54) between the connecting sections (7) and the second potential surface (10).

7. The antenna array as recited in one of claims 4 through 6,
wherein the thickness of the at least one layer (51) of the carrier (5) between the couplings devices (3) and the connecting sections (7) is approximately half or approximately a third of the thickness of the at least one layer (52, 53, 54) between the connecting sections (7) and the second potential surface (10).

8. The antenna array as recited in one of the preceding claims,
wherein the transmission and receiving devices (2) are embodied as right-angled radiator surface (patches) (2).

9. The antenna array as recited in one of the preceding claims,
wherein the individual layers (51, 52, 53, 54, 55) of the carrier (5) are made of a dielectric ceramic (LTCC ceramic), which may be fired at low temperature, the individual layers (51, 52, 53, 54, 55) melting together.

10. The antenna array as recited in one of the preceding claims,
wherein the individual layers (51, 52, 53, 54, 55) of the carrier (5) each have a thickness of approximately 150 xxxm.

11. The antenna array as recited in one of the preceding claims,
wherein the transmission and receiving devices (2) are arranged in series and set apart from each other by a predefined clearance.

12. The antenna array as recited in one of the preceding claims,
wherein the coupling devices (3) are provided in the form of coupling slots (3).

13. The antenna array as recited in claim 12, wherein the coupling slots (3) are produced by etching of the first potential surface (4).

14. The antenna array as recited in one of claims 8 through 13,
wherein one coupling device (3) in each case extends in a centrical manner underneath a radiator surface (2), approximately across its breadth.

15. The antenna array as recited in one of claims 12 through 14,
wherein the connecting sections (7) are embodied as feed lines (7) in a carrier plane, perpendicularly to the coupling slots (3).

16. The antenna array as recited in one of the preceding claims,
characterized by essentially vertically extending contactings (12) to form a shield from electromagnetic radiation.

17. The antenna array as recited in claim 16, wherein the contactings (12) are arranged in parallel to each other.

18. The antenna array as recited in claim 17, wherein the contactings (12) are set apart from each other at a distance that is less than the wavelength of the radiation to be shielded from.

19. The antenna array as recited in one of the preceding claims,
wherein the transmission and receiving devices (2) are affixed on a suitable foam layer.

20. The antenna array as recited in one of the preceding claims,
wherein the transmission and receiving devices (2) are affixed on a housing top of the array.

21. The antenna array as recited in one of the preceding claims,
wherein the connecting sections (7) are in each case electrically connected by at least one contacting device (13) to a supply network device (14) arranged on a surface of the carrier (5).

22. The antenna array as recited in one of the preceding claims,
wherein the transmission and receiving devices (2), the potential surfaces (4, 10), the connecting sections (7), the contactings (12) and the contact devices (13) are made of an electrically conductive material, such as gold, silver, copper or aluminum.

23. The antenna array as recited in one of the preceding claims,
wherein connecting sections and/or contact devices are formed using microstrip and/or coplanar technologies.

24. The antenna array as recited in one of claims 12 through 23,
wherein the coupling slots (3) may be embodied in arbitrary form, such as straight lines, H-form, U-form etc.
